(19) United States
(12) Patent Application Publication
(10) Pub. No.: US 2010/0251500 A1
(43) Pub. Date: Oct. 7, 2010

(54) PAINTING ROLLER WITH A FABRICATING MATOD THEREOF

(75) Inventor: CHIH-MING LIN, Kaohsiung (TW)

Correspondence Address: G. LINK CO., LTD., 3550 BELL ROAD, MINOOKA, IL, 60447, US

(73) Assignee: GEENG MIING TRADING CO., LTD., Kaohsiung (TW)

(21) Appl. No.: 12/418,567

(22) Filed: Apr. 4, 2009

(51) Int. Cl. B05C 17/02; B28B 11/14

(52) U.S. Cl. 15/230.11; 264/145

(57) ABSTRACT

A painting roller with a fabricating method thereof includes a main roller member, yarns and a flannelet layer. The main roller member made of a Polypropylene (PP) strip spirally wound with a winding machine. The yarns and the flannelet layer are spirally wound on the main roller with the winding machine and the main roller bonds the yarns and the flannelet layer together with a melted plastic liquid sprayed on the main roller. Hence, the painting roller is fast fabricated with low cost and high quality effectively.

### BACKGROUND OF THE INVENTION

1. Field of the Invention

The present invention is related to a roller with a fabricating method thereof and particularly to a painting roller with a fabricating method thereof.

2. Brief Description of the Related Art

In the field of paint coating, it is preferable that a large area of wall or region is painted with a painting roller for meeting the actual need and yielding twice the result with half the effort. Referring to FIG. 1, the conventional painting roller has a handle 10 with a bent lever 11 extending forward to form a support shaft to fit with a roller 20. The roller 20 has a cylinder 21 attached with a cloth sleeve 22, which is capable of being soaked with the paint. Thus, the conventional painting roller can be performed to frictionally move the cloth sleeve 22 with paint on the wall back and forth for the painting job. Referring to FIG. 2, the roller 20 is fabricated by that the cylinder 21 is made of plastics first and then the cloth sleeve 22 is glued to the outer surface of the cylinder 21 with the adhesive. However, the preceding fabrication for the roller is low efficiency with high cost, and the bonding force of the adhesive between the cylinder 21 and the cloth sleeve 22 is easy to be deprived due to corrosion of the paint. Referring to FIG. 3, another way of the fabrication for the roller 20 is that a plastic strip 23 and a flannelet strip 24 are wound on a rod mold 30 with a winding machine 30 with the adhesive treated between the plastic strip 23 and the flannelet strip 24 to form the roller. Although the roller 20 fabricated with the winding machine 30 provides a higher efficiency and a lower cost, the formation of the roller 20 is based on the plastic strip 23 bound with the flannelet strip 24 and the gluing force of the adhesive and it is easy to be deformed to create the wound slits 25 as shown in FIG. 4. As a result, not only the integral performance of the roller 20 is deteriorated but also the adhesive tightness is doubtful due to the large deformation of the cylinder is unfavorable for the plastic strip 23 and the flannelet strip 24 to keep gluing to each other.

### SUMMARY OF THE INVENTION

In order to improve the deficiencies of the conventional roller, a painting roller with a method for fabricating the roller in accordance with the present invention is disclosed to promote the production efficiency, lower the production cost and enhance the quality. The painting roller of the present invention includes a main roller member, a plurality of yarns and a flannelet layer. The main roller member is made of a Polypropylene (PP) strip wound by a winding machine. The yarns and the flannelet layer are spirally wound on the main roller by the winding machine and the main roller is sprayed with a melted plastic liquid to bond with the yarns and the flannelet layer firmly.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a perspective view of the conventional painting roller;

FIG. 2 is a disassembled perspective view of the conventional painting roller shown in FIG. 1.

FIG. 3 is a plan view illustrating another type of the conventional painting roller being formed;

FIG. 4 is a plan view of the conventional painting roller shown in FIG. 3;

FIG. 5 is a partly sectional perspective view of a painting roller according to the present invention; and

FIG. 6 is a plan view illustrating the painting roller shown in FIG. 5 in the process of being fabricated.

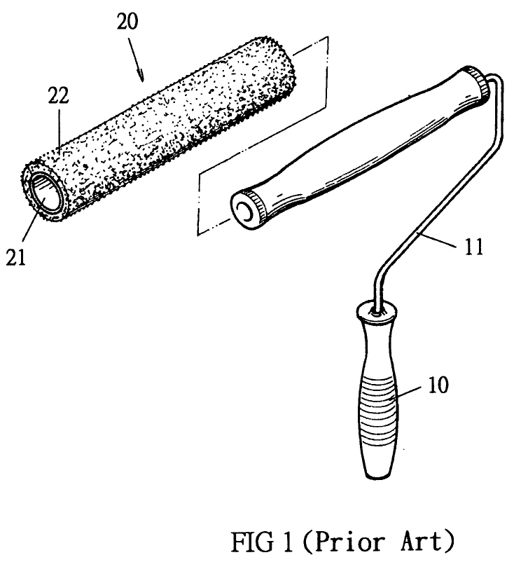

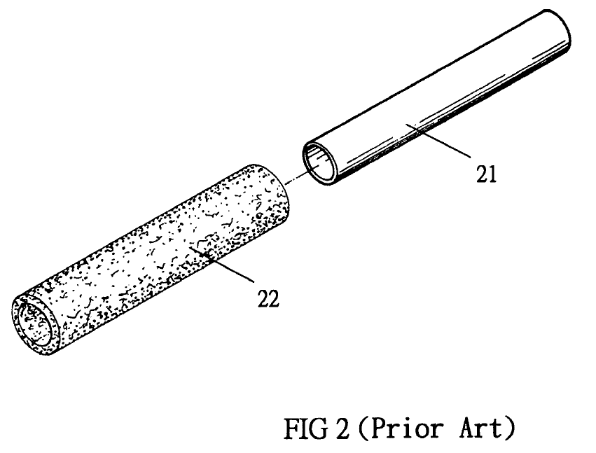

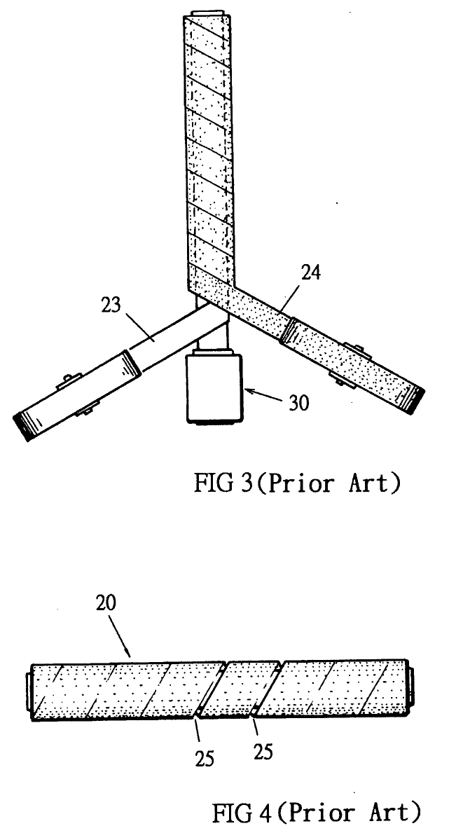

### DETAILED DESCRIPTION OF THE INVENTION

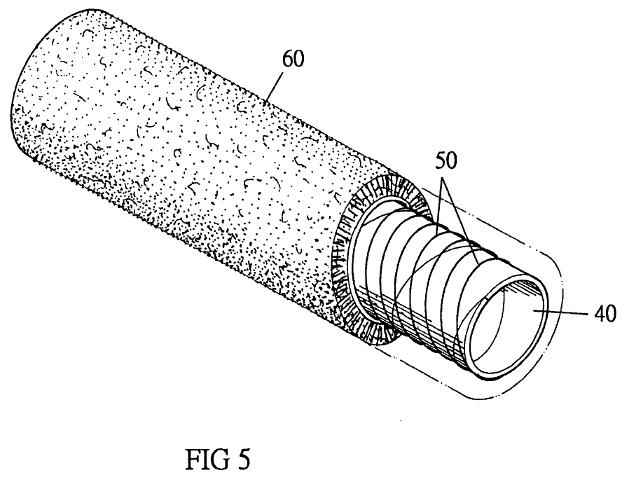

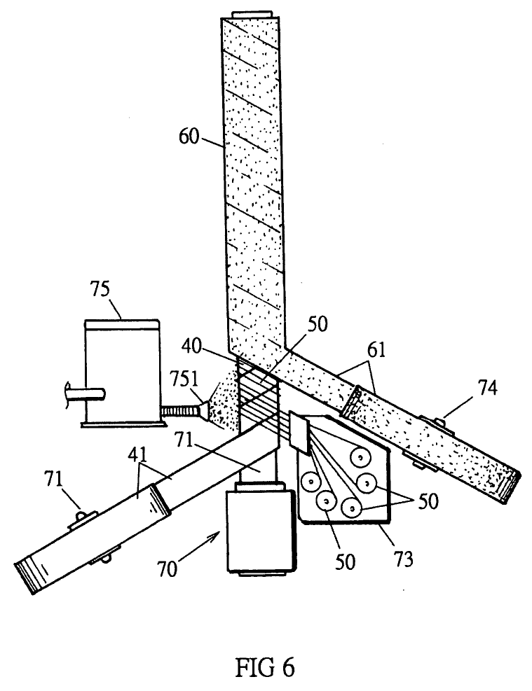

Referring to FIGS. 5 and 6, a painting roller according to the present invention includes a main roller member 40, a plurality of yarns 50 and a flannelet layer 60. The main roller member 40 is tubular and made with a Polypropylene (PP) strip 41. It can be seen in FIG. 6 that the PP strip 41 on a PP roll is spirally wound around to a rotational rod mold 72 through a feed device 71 of a winding machine 70 to form the hollow main roller member 40. Preset amounts of the yarns 50 are transmitted to the rotational mold stick 72 via a yarn collector 73 of the winding machine 70 to spirally wind on the surface of the main roller member 40. A flannelet strip 61 with a preset width from a flannelet roll is delivered to spirally wind the outer surface of the yarns 50 via the feed device 74 of the winding machine 70 to surround the yarns 50 and form the flannelet layer 60.

The winding machine 70 further includes a thermal fusion device 75 to melt a plurality of PP pellets as plastic liquid for being sprayed on the outer surface of the main roller member 40 evenly such that the yarns 50 and the flannelet layer 60, which are spirally wound on the main roller member 40, are capable of being joined to the main roller member 40 before the plastic liquid cools down and becomes hardened. Hence, an integral bonding state is formed between the main roller member 40 and the flannelet layer 60, and the yarns 50 hold the outer surface of the main roller member 40 for the main roller member 40 constituting a roller blank. Finally, the roller blank is cut and trimmed by the winding machine 70 as a finished roller with a preset length.

It is noted that the flannelet layer 60 is delivered from the flannelet roll 61 in addition to the PP roll 41 as shown in FIG. 6 such that the feeding devices 71, 74 of the winding machine 70 are capable of inputting the PP strip 41 and the flannelet layer 60 continuously and the roller blank can be cut and trimmed immediately. Further, it is not necessary to prepare a molding tool for making the main roller member 40. In this way, the production efficiency is promoted tremendously and the unnecessary waste material is avoidable. Furthermore, the outer surface of the main roller member 40 is wound with the yarns 50 such that the main roller member 40 is formed firmly due to being held tightly with the binding force of the yarns 50. Additionally, the flannelet strip 61 spirally winding the outer surface of the main roller member 40 forms the flannelet layer 60 and the PP pellets melted and sprayed on the outer surface of the main roller member 40 bond the main roller member 40 and the flannelet layer 60 together soundly. Under this circumference, the painting roller and the fabrication method thereof with the objects of fast fabrication, low cost and good quality can be achieved effectively.

It is respectfully noted that materials recited in the preceding embodiment of the present invention such the PP strip 41, the yarns 50 and the flannelet layer 60 are exemplary and the equivalent materials can be employed as well. Polyethylene roll can be used to substitute the PP roll 41; the cotton threads and the nylon threads can be used instead of the yarns 50; and the cotton layer or the gauze layer can be used instead of the flannelet layer 60.

While the invention has been described with referencing to preferred embodiment thereof, it is to be understood that modifications or variations may be easily made without departing from the spirit of this invention, which is defined by the appended claims.

What is claimed is:

1. A painting roller comprising:
a main roller member made of a spirally wound Polypropylene (PP) strip;
a plurality of yarns spirally winding around the outer surface of said main roller member; and
a flannelet layer spirally winding around the outer surface of said roller member;
wherein said roller member, said yarns and said flannelet layer are bonded by a melted plastic liquid, which is sprayed and cooled on said roller member.

2. A method for fabricating a painting roller comprising following steps:
providing a rotational rod mold;
delivering a PP strip on a PP roll to said rod mold with a feeding device of a winding machine;
spirally winding said PP strip around said rod mold to form a tubular shaped main roller member;
delivering a plurality of yarns to said rod mold via a yarn collector of said winding machine and spirally winding said yarns on the outer surface of said main roller member;
delivering a flannelet layer on a flannelet roll to said rod mold with said feeding device and spirally winding said flannelet layer on the outer surface of said main roller member;
spraying a melted PP liquid, which is obtained with a plurality of PP pellets treated with a thermal fusion device of said winding machine, on the outer surface of said main roller member evenly;
bonding said main roller member, said yarns and said flannelet layer together in the process of said melted PP liquid cooling and hardening;
forming a roller blank after said melted PP liquid is cooled and hardened; and
cutting and trimming said roller blank to a preset length as a finished paining roller.
